(19) United States
(12) Patent Application Publication
(10) Pub. No.: US 2025/0079065 A1
(43) Pub. Date: Mar. 6, 2025

(54) TRANSFORMER

(71) Applicant: Delta Electronics (Shanghai) Co., Ltd., Shanghai (CN)

(72) Inventors: Yanwei HU, Shanghai (CN); Xianfu OU, Shanghai (CN); Xueyong ZHAI, Shanghai (CN); Hsieh Shen HSIEH, Shanghai (CN)

(21) Appl. No.: 18/646,792

(22) Filed: Apr. 26, 2024

(30) Foreign Application Priority Data
Aug. 28, 2023 (CN) 202311093589.X

(51) Int. Cl. H01F 27/28; H01F 27/06; H01F 27/24

(52) U.S. Cl. CPC H01F 27/28; H01F 27/06; H01F 27/24

(57) ABSTRACT

A transformer includes a winding frame, a first magnetic core, a second magnetic core, and a winding. The winding frame includes two side walls along a first direction and a bottom wall. Along a second direction, both sides of the bottom wall are each provided with a stop plate. A length of the stop plate in a third direction is less than a length of each of the two side walls in the third direction. The bottom wall, the two side walls and the two stop plates together around form a mounting part. The first magnetic core is at least partially located in the mounting part. The winding is wound on an outer side of the first magnetic core, the bottom wall and the two stop plates. The second magnetic core, outside of the winding, is provided covering part of the winding, and is connected to the first magnetic core.

### CROSS-REFERENCE TO RELATED APPLICATION

This application claims priority to Chinese Patent Application No. 202311093589.X, filed on Aug. 28, 2023, which is hereby incorporated by reference in its entirety.

### TECHNICAL FIELD

This application relates to a field of electrical equipment technology, particularly to a transformer.

### BACKGROUND

A transformer is an important component in an electrical equipment, used to adjust different voltages, so that the voltage can reach an applicable range of the electrical equipment, thereby enabling the electrical equipment to operate.

FIG. 1 is an explosion view of a transformer in the prior art. Referring to FIG. 1, where the transformer includes a winding frame 100, a magnetic core 200, a winding 300, an insulating tape 400 and a suction part 500. The winding frame 100 includes a base 101 and a winding part 102 disposed in the middle of the base 101. The winding part 102 is disposed protruding from the base 101. A wire groove 104 is formed on an outer surface of the winding part 102. The winding 300 is wound in the wire groove 104. The winding part 102 is further provided with a through hole 103 therein. An axis of the through hole 103 is perpendicular to the winding 300. At least part of the magnetic core 200 is provided by penetrating in the through hole 103 along the axis of the through hole 103, and the remaining part of the magnetic core 200 is disposed on the base 101 and surrounds the winding 300.

However, the inventor realized that since the winding part 102 is disposed protruding from the base 101, a space below the winding part 102 and between bases 101 cannot be used, so that an overall size of the transformer is relatively large, which is not conducive to miniaturization of the transformer.

### SUMMARY

In order to overcome the above-mentioned defects in the related art, the purpose of the present application is to provide a transformer. The present application is beneficial to reducing a size of the transformer.

The present application provides a transformer including a winding frame, a first magnetic core, a second magnetic core and a winding, where the winding frame includes two side walls oppositely disposed along a first direction and a bottom wall connecting the two side walls; along a second direction, both sides of the bottom wall are each provided with a stop plate; a length of the stop plate in a third direction is less than a length of each of the two side walls in the third direction; the bottom wall, the two side walls and the two stop plates together around form a mounting part; the first magnetic core is at least partially located in the mounting part; the winding is wound on an outer side of the first magnetic core, the bottom wall and the two stop plates; the second magnetic core, outside of the winding, is provided covering part of the winding, and is connected to the first magnetic core;
where, the first direction, the second direction and the third direction are perpendicular to each other.

In the present application, the first magnetic core is disposed in the mounting part located inside the winding frame, and the winding is wound on the outer side of the first magnetic core, so that there is an overlap part between the magnetic core with the winding and each of the two side walls in the third direction. That is to say, the installation of the magnetic core and the winding makes more use of a space inside the winding frame, which reduces a length of the transformer in the third direction compared with the solution in the related art, which is beneficial to reducing the overall size of the transformer, and meets a development need for miniaturization of the transformer.

### BRIEF DESCRIPTION OF DRAWINGS

In order to more clearly illustrate the technical solutions in embodiments of the present application or related technologies, attached drawings required for describing the embodiments or related technologies are briefly introduced below. Apparently, the attached drawings in the following description are some embodiments of the present application, and those of ordinary skill in the art may further obtain other drawings based on these attached drawings without creative efforts.

FIG. 1 is an explosion view of a transformer in the prior art.

FIG. 2 is a structural schematic diagram of a transformer provided by an embodiment of the present application.

FIG. 3 is an explosion view of a transformer provided by an embodiment of the present application.

FIG. 4 is an explosion view of a transformer provided by another embodiment of the present application.

FIG. 5 is a structural schematic diagram of a magnetic core provided by an embodiment of the present application.

FIG. 6 is a structural schematic diagram of a winding frame provided by an embodiment of the present application.

FIG. 7 is a structural schematic diagram of a winding frame provided by another embodiment of the present application.

### DESCRIPTION OF EMBODIMENTS

To make objectives, technical solutions, and advantages of the embodiments of the present application clearer, the following clearly and completely describes the technical solutions in the embodiments of the present application with reference to the attached drawings in the embodiments of the present application. Apparently, the described embodiments are only a part rather than all of the embodiments of the present application.

Based on the embodiments in the present application, all other embodiments obtained by those of ordinary skill in the art without making creative efforts shall fall within a protection scope of the present application. In a case of no conflict, the following embodiments and features in the embodiments can be combined with each other.

As described in the background art, in the transformer of the related art, since a structure of the winding frame includes the base and the winding part protruded from the base, the winding and the magnetic core are both located above the base, a height of the transformer is relatively high, and the overall size is relatively large, which is not conducive to its miniaturization.

In view of this, an embodiment of the present application is directed to provide a transformer, by forming a mounting part inside a winding frame, disposing a first magnetic core in the mounting part, and winding a winding on an outer side of the first magnetic core, there is an overlap part between the magnetic core with the winding and a side wall in a height direction, thereby reducing a height of the transformer and reducing an overall size of the transformer.

The following describes contents of the embodiments of the present application in detail with reference to the attached drawings, so that those skilled in the art can understand the contents of the present application in more detail.

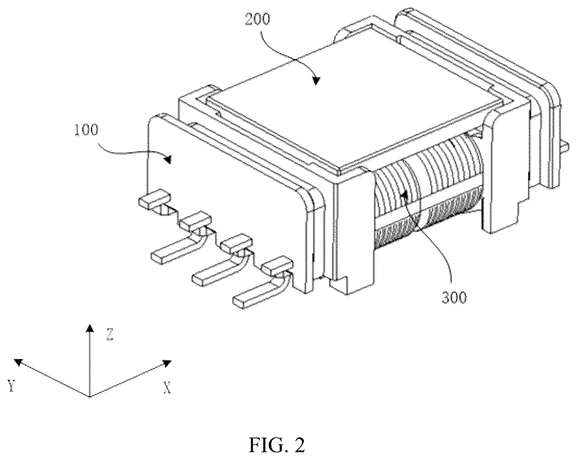

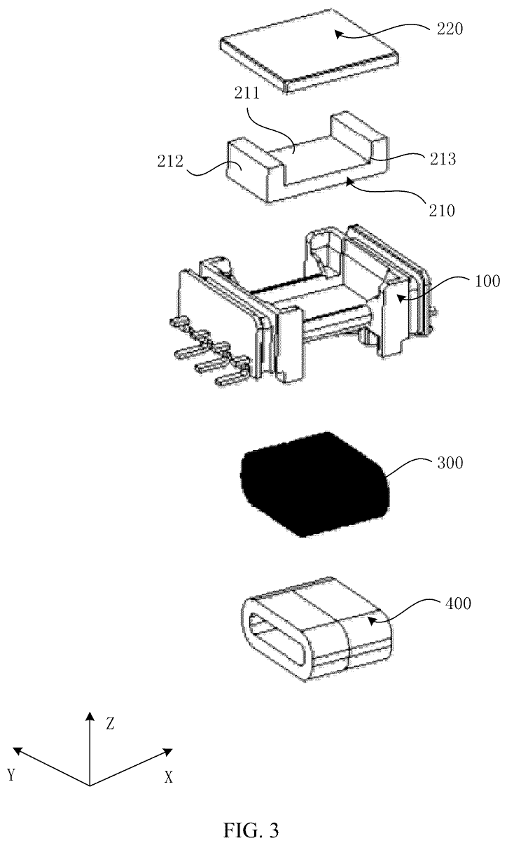

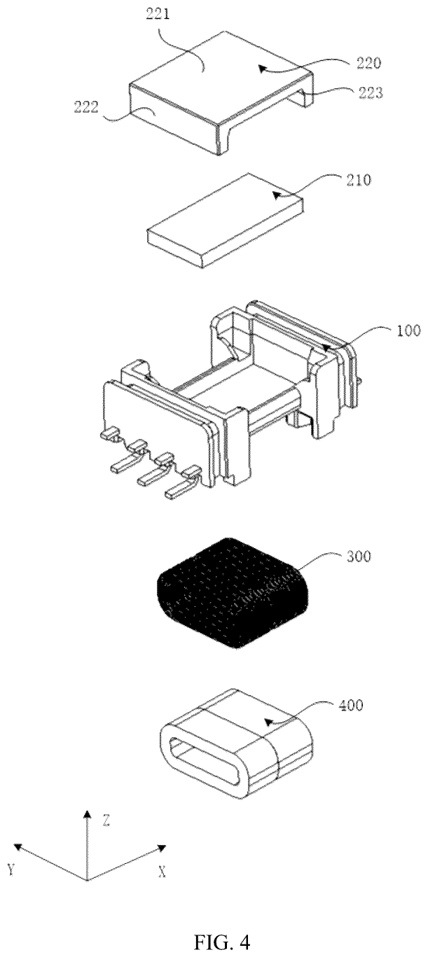

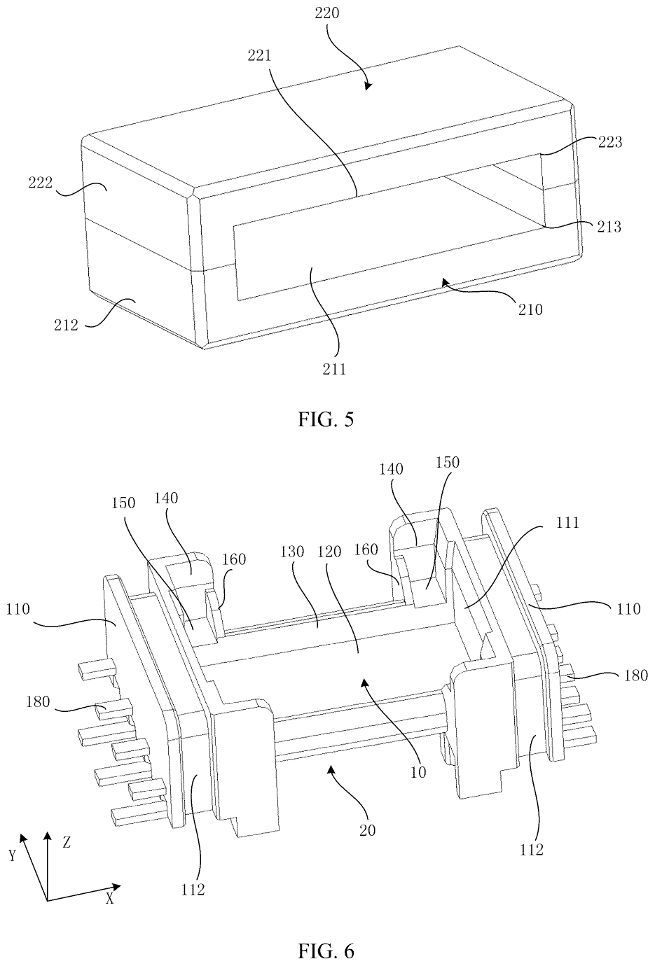

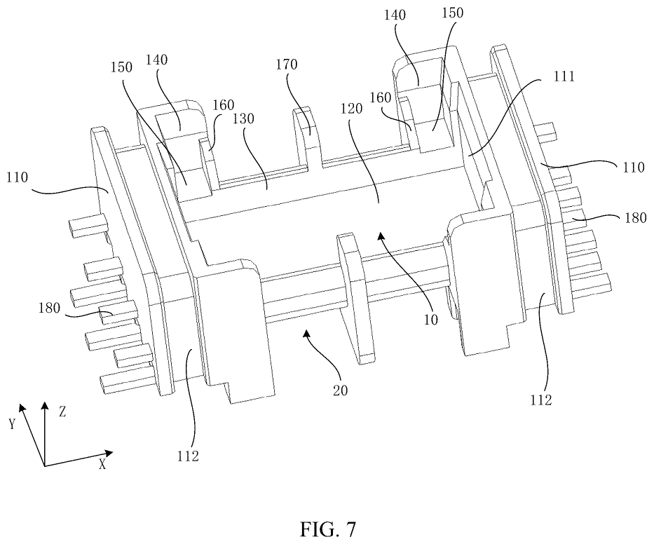

FIG. 2 is a structural schematic diagram of a transformer provided by an embodiment of the present application; FIG. 3 is an explosion view of a transformer provided by an embodiment of the present application; FIG. 4 is an explosion view of a transformer provided by another embodiment of the present application; FIG. 5 is a structural schematic diagram of a magnetic core provided by an embodiment of the present application; FIG. 6 is a structural schematic diagram of a winding frame provided by an embodiment of the present application; FIG. 7 is a structural schematic diagram of a winding frame provided by another embodiment of the present application. In this embodiment, a first direction X, a second direction Y, and a third direction Z are three different directions perpendicular to each other in a three-dimensional space, where the third direction Z may be, for example, a height direction (vertical direction).

Referring to FIG. 2 to FIG. 7, the present application provides a transformer, including a winding frame 100, a magnetic core 200 and a winding 300.

The winding frame 100 includes two side walls 110 oppositely disposed along the first direction X and a bottom wall 120 connecting the two side walls 110, and the bottom wall 120 may be disposed perpendicular to each of the two side walls 110. Along the second direction Y, both sides of the bottom wall 120 are each provided with a stop plate 130, and the stop plate 130 is disposed perpendicular to both each of the two side walls 110 and the bottom wall 120. Along the first direction X, the stop plate 130 may extend from one of the two side walls 110 on one side to another one of the two side walls 110 on the other side, or the stop plate 130 may be disposed only in a partial region between the two side walls 110. In the embodiment, the stop plate 130 extends from the one of the two side walls 110 on the one side to the another one of the two side walls 110 on the other side. A length of the stop plate 130 in the third direction Z is less than a length of each of the two side walls 110 in the third direction Z to form a notch in the second direction Y. In this embodiment, the bottom wall 120, the two side walls 110 and the two stop plates 130 together around form a mounting part 10. As shown in FIG. 6 and FIG. 7, the mounting part 10 is equivalent to a groove provided in the winding frame 100, and both sides of the groove are provided with notches in the second direction Y, thus forming the stop plate 130 whose height is lower than that of each of the two side walls 110, so as to facilitate subsequent assembly of the magnetic core 200 and the winding 300.

The magnetic core 200 includes a first magnetic core 210 and a second magnetic core 220, where the first magnetic core 210 is at least partially located within the mounting part 10. Exemplarily, a volume of the first magnetic core 210 is adapted to a volume of the mounting part 10, so that the mounting part 10 may be filled. The winding 300 is wound around the outer sides of the first magnetic core 210, the bottom wall 120, and the two stop plates 130 with an axis parallel to the first direction X. The second magnetic core 220, outside of the winding 300, covers part of the winding 300 and is connected to the first magnetic core 210. Exemplarily, the first magnetic core 210 and the second magnetic core 220 together around form a structure with an opening in the second direction Y, and part of the winding 300 is provided by penetrates in the opening.

In this embodiment, through disposing the first magnetic core 210 in the mounting part 10 located inside the winding frame 100, and winding the winding 300 on the outer side of the first magnetic core 210, there is an overlap part between the magnetic core 200 with the winding 300 and each of the two side walls 110 in the third direction Z. That is, the installation of the magnetic core 200 and the winding 300 makes more use of a space inside the winding frame 100, which reduces a length of the transformer in the third direction Z compared with the solution in the related art, which is beneficial to reducing the overall size of the transformer, and meets a development need for miniaturization of the transformer.

Referring to FIG. 6 and FIG. 7, in some possible implementations, in the third direction Z, the bottom wall 120 is connected to a middle part of the two side walls 110, and the bottom wall 120 and the two side walls 110 together form a winding space 20. The winding 300 is wound on the first magnetic core 210, the bottom wall 120 and the two stop plates 130 and is located within the winding space 20, so that a length of the winding 300 in the third direction Z is less than a length of each of the two side walls 110 in the third direction Z. That is, the winding 300 is not exposed from the winding frame 100 in the third direction Z, which is beneficial to further reducing the length of the transformer in the third direction Z and reducing the size of the transformer.

Referring to FIG. 3, in some possible implementations, the second magnetic core 220 of this embodiment is cuboid-shaped, the first magnetic core 210 includes a first top pillar 211 and first side pillars 212 vertically connected to two opposite ends of the first top pillar 211, and the first top pillar 211 and the first side pillars 212 located on both sides of the first top pillar together around form a structure with a substantially “C”-shaped cross section. An end of each of the first side pillars 212 away from the first top pillar 211 is connected to the second magnetic core 220, thereby forming a closed loop.

In the second direction Y, a length of the second magnetic core 220 is less than or equal to a length of the first top pillar 211, and this arrangement can reduce a probability of misalignment between the first magnetic core 210 and the second magnetic core 220 in the second direction Y during assembly. Meanwhile, since a top surface of the second magnetic core 220 serves as a top surface of the transformer, it itself can serve as a suction part 500, thereby omitting the suction part 500 in the prior art. In other embodiments of the present disclosure, in a plane perpendicular to the third direction Z, a projected area of the second magnetic core 220 is greater than or equal to a projected area of the first magnetic core 210. As a result, the area of the second magnetic core 220 is larger, which is more beneficial to being used as the suction part 500.

In a plane perpendicular to the first direction X, a projected area of the second magnetic core 220 is equal to a projected area of the first top pillar 211. In this embodiment, in the plane perpendicular to the first direction X, a projection of the second magnetic core 220 and a projection of the first top pillar 211 are both squares. An area of a square is equal to a base length multiplied by a height. Lengths of the second magnetic core 220 and the first top pillar 211 in the second direction Y are respective base lengths, and lengths in the third direction Z are respective heights. The length of the second magnetic core 220 in the second direction Y is less than or equal to the length of the first top pillar 211 in the second direction Y, and the projected area of the second magnetic core 220 in the plane perpendicular to the first direction X is equal to the projected area of the first top pillar 211 in the plane perpendicular to the first direction X, therefore the length of the second magnetic core 220 in the third direction Z is necessarily greater than or equal to the length of the first top pillar 211 in the third direction Z. That is to say, the first top pillar 211 in this embodiment has a smaller height, which facilitates reducing the overall height of the transformer, so as to reduce the size of the transformer. It should be noted that the “equal to” in a case that the projected area of the second magnetic core 220 in the plane perpendicular to the first direction X is equal to the projected area of the first top pillar 211 in the plane perpendicular to the first direction X is not absolutely the same in a mathematical sense, and its meaning is that designs of the two are basically equivalent, and a difference between the two is within 10% in an implementation.

Further, in the first direction X, the length of the second magnetic core 220 is greater than or equal to the length of the first magnetic core 210, thus ensuring that the two first side pillars 212 of the first magnetic core 210 both can be in contact with the second magnetic core 220, so as to reduce a difficulty in assembling the first magnetic core 210 and the second magnetic core 220.

In some examples, a first transition surface 213 is further provided between the first top pillar 211 and each of the first side pillars 212 of this embodiment, and the first transition surface 213 is an inclined surface or an arc surface. By disposing the first transition surface 213, a connection thickness between the first top pillar 211 and each of the first side pillars 212 is increased, thereby avoiding stress concentration at a connection place between the first top pillar 211 and each of the first side pillars 212, and improving an overall strength of the first magnetic core 210. In addition, a probability of each of the first side pillars 212 scratching the winding 300 during an assembling process can be reduced.

Referring to FIG. 4, in some possible implementations, the first magnetic core 210 of this embodiment is cuboid-shaped, the second magnetic core 220 includes a second top pillar 221 and second side pillars 222 vertically connected to two opposite ends of the second top pillar 221, and the second top pillar 221 and the second side pillars 222 located on both sides of the second top pillar together around form a structure with a substantially “C”-shaped cross section. An end of each of the second side pillars 222 away from the second top pillar 221 is connected to the first magnetic core 210, thereby forming a closed loop.

In the second direction Y, a length of the first magnetic core 210 is less than or equal to a length of the second top pillar 221, and this setting can reduce a probability that the first magnetic core 210 and the second magnetic core 220 are misaligned in the second direction Y during assembly.

In a plane perpendicular to the first direction X, a projected area of the first magnetic core 210 is equal to a projected area of the second top pillar 221. In this embodiment, in the plane perpendicular to the first direction X, a projection of the first magnetic core 210 and a projection of the second top pillar 221 are both squares. An area of a square is equal to a bottom edge length multiplied by a height. Lengths of the first magnetic core 210 and the second top pillar 221 in the second direction Y are respective bottom edge lengths, and lengths in the third direction Z are respective heights. The length of the first magnetic core 210 in the second direction Y is less than or equal to the length of the second top pillar 221 in the second direction Y, and the projected area of the first magnetic core 210 in the plane perpendicular to the first direction X is equal to the projected area of the second top pillar 221 in the plane perpendicular to the first direction X, therefore the length of the first magnetic core 210 in the third direction Z is necessarily greater than or equal to the length of the second top pillar 221 in the third direction Z. That is to say, the second top pillar 221 in this embodiment has a smaller height, which facilitates reducing the overall height of the transformer, so as to reduce the size of the transformer. It should be noted that the “equal to” in a case that the projected area of the first magnetic core 210 in the plane perpendicular to the first direction X is equal to the projected area of the second top pillar 221 in the plane perpendicular to the first direction X is not absolutely the same in a mathematical sense, and its meaning is that designs of the two are basically equivalent, and a difference between the two is within such as 10% in an implementation.

Further, in the first direction X, the length of the first magnetic core 210 is greater than or equal to the length of the second magnetic core 220, thus ensuring that the two second side pillars 222 of the second magnetic core 220 both can be in contact with the first magnetic core 210, so as to reduce a difficulty in assembling the first magnetic core 210 and the second magnetic core 220.

In some examples, a second transition surface 223 is provided between the second top pillar 221 and each of the second side pillars 222 of this embodiment, and the second transition surface 223 may be an inclined surface or an arc surface. By disposing the second transition surface 223, a connection thickness between the second top pillar 221 and each of the second side pillars 222 is increased, thereby avoiding stress concentration at a connection place between the second top pillar 221 and each of the second side pillars 222, and improving an overall strength of the second magnetic core 220. In addition, a probability of each of the second side pillars 222 scratching the winding 300 during an assembling process can be reduced.

Referring to FIG. 5, in some possible implementations, the first magnetic core 210 of this embodiment includes a first top pillar 211 and first side pillars 212 vertically connected to two opposite ends of the first top pillar 211, and the first top pillar 211 and the first side pillars 212 located on both sides of the first top pillar together around form a structure with a substantially “C”-shaped cross section. The second magnetic core 220 includes a second top pillar 221 and second side pillars 222 vertically connected to two opposite ends of the second top pillar 221, and the second top pillar 221 and the second side pillars 222 located on both sides of the second top pillar together around form a structure with a substantially “C”-shaped cross section. In other words, both the first magnetic core 210 and the second magnetic core 220 in this embodiment adopt the structure with the “C”-shaped cross section. An end of one of the first side pillars 212 away from the first top pillar 211 is connected to a corresponding end of one of the second side pillars 222 away from the second top pillar 221, thereby forming a closed loop.

Further, a first transition surface 213 is further provided between the first top pillar 211 and each of the first side pillars 212, and the first transition surface 213 is an inclined surface or an arc surface. By disposing the first transition surface 213, a connection thickness between the first top pillar 211 and each of the first side pillars 212 is increased, thereby avoiding stress concentration at a connection place between the first top pillar 211 and each of the first side pillars 212, and improving an overall strength of the first magnetic core 210. In addition, a probability of each of the first side pillars 212 scratching the winding 300 during an assembling process can be reduced.

A second transition surface 223 is provided between the second top pillar 221 and each of the second side pillars 222, and the second transition surface 223 may be an inclined surface or an arc surface. By disposing the second transition surface 223, a connection thickness between the second top pillar 221 and each of the second side pillars 222 is increased, thereby avoiding stress concentration at a connection place between the second top pillar 221 and each of the second side pillars 222, and improving an overall strength of the second magnetic core 220. In addition, a probability of each of the second side pillars 222 scratching the winding 300 during an assembling process can be reduced.

Referring to FIG. 2, FIG. 6 and FIG. 7, in some possible implementations, in order to better implement an installation of the winding 300, in the second direction Y, a length of the bottom wall 120 is less than a length of each of the two side walls 110, two ends of each of the two side walls 110 are each further provided with a stop wall 140, and the stop wall 140 is perpendicular to the second direction Y and is disposed toward the winding 300. In the first direction X, a notch for the winding 300 to pass through is formed between the two adjacent stop walls 140, thus the winding 300 may be located in two notches on both sides of the bottom wall 120 in the second direction Y, thereby a length of the winding 300 in the second direction Y is less than a length of each of the two side walls 110 in the second direction Y. That is, the winding 300 is not exposed from the winding frame 100 in the second direction Y, which is beneficial to further reducing the length of the transformer in the second direction Y and reducing the size of the transformer.

Further, in order to achieve an assembly of the first magnetic core 210 and the second magnetic core 220, an end of the stop plate 130 of the present embodiment away from the bottom wall 120 is provided with an abutting plate 150 connected to the stop wall 140. Combining FIG. 6 and FIG. 7, it can be understood that the abutting plate 150 is parallel to the bottom wall 120 and the abutting plates 150 are located at four corners above the bottom wall 120. The abutting plate 150 is vertically connected to each of the two side walls 110, the stop wall 140 and the stop plate 130, and during assembly, the adhesive may be dispensed to a surface of the abutting plate 150 to facilitate assembly of the magnetic core 200.

Continue to refer to FIG. 6 and FIG. 7, in some possible implementations, a side of each of the two side walls 110 toward the winding 300 is further provided with a recessed part 111, and the bottom wall 120 is connected to a position where each of the two side walls 110 is provided with the recessed part 111. Optionally, the bottom wall 120 and each of the two side walls 110 may be integrally provided, for example, be integrally provided through an injection molding process.

Continue to refer to FIG. 6 and FIG. 7, in some possible implementations, in the first direction X, a limiting plate 160 is further connected to an end of the abutting plate 150 away from a corresponding one of the two side walls 110, the limiting plate 160 is disposed perpendicular to the first direction X, and two ends of the limiting plate 160 in the second direction Y are respectively connected to the stop plate 130 and the stop wall 140. The winding 300 is located between the two limiting plates 160 opposite to each other in the first direction X, and the limiting plate 160 can prevent the winding 300 from contacting each of the second side pillars 222, thereby ensuring security of the transformer in use.

In some examples, a surface of the limiting plate 160 away from the bottom wall 120 is an inclined surface or an arc surface, and the surface may be inclined from a side of the stop wall 140 to a side of the bottom wall 120. With the above structure, a probability of the limiting plate 160 scratching the winding 300 can be reduced.

Referring to FIG. 2, FIG. 6 and FIG. 7, in some possible implementations, at least one pin 180 is further provided on a side of each of the two side walls 110 away from the winding 300 in the first direction X in this embodiment. The winding 300 includes a first winding and a second winding, where the first winding may be, for example, a high voltage side winding and the second winding may be, for example, a low voltage side winding. The first winding is provided with at least one lead wire to connect a pin 180 on the one of the two side walls 110 at the one side, and the second winding is provided with at least one lead wire to connect a pin 180 on the another one of the two side walls 110 at the other side. In this embodiment, each of the two side walls 110 is provided with a plurality of pins 180, and the plurality of pins 180 are arranged in two rows, top and bottom, in the third direction Z, and each row includes a plurality of pins 180. In the third direction Z, the pins 180 are located at an end of a corresponding one of the two side walls 110 away from the second magnetic core 220, so that the pins 180 have larger safe distances to ensure security of the transformer in use.

In some possible implementations, when the winding frame 100 as shown in FIG. 6 is used, the first winding and the second winding of this embodiment are disposed separating from each other along the first direction X, and in order to ensure insulation, an insulating tape 400 may be wound on outer sides of both the first winding and the second winding.

As shown in FIG. 7, in some possible implementations, in the first direction X, a partition plate 170 is provided in a middle part of the stop plate 130, when the winding frame 100 as shown in FIG. 5 is used, the first winding and the second winding may be respectively located on two sides of the partition plate 170, and the outer sides of the first winding and the second winding are still wound with the insulating tape 400, thereby the insulation between the first winding and the second winding is further improved.

Continue to refer to FIG. 6 and FIG. 7, in some possible implementations, a safe distance groove 112 is provided on each of the two side walls 110, and the safe distance groove 112 is used to increase a creepage distance between the pin 180 and the first magnetic core 210 and/or the second magnetic core 220.

Exemplarily, the safe distance groove 112 of this embodiment surrounds each of the two side walls 110 with an axis parallel to the first direction X. Each of the two side walls 110 includes a first surface and a third surface oppositely disposed along the second direction Y and a second surface and a fourth surface oppositely disposed along the third direction Z, and the safe distance groove 112 includes a first groove segment disposed on the first surface, a second groove segment disposed on the second surface, a third groove segment disposed on the third surface, and a fourth groove segment disposed on the fourth surface, where the first groove segment, the second groove segment, the third groove segment, and the fourth groove segment are interconnected with each other.

Through the above setting, the safe distance groove 112 must be passed from the pin 180 to the first magnetic core 210 or the second magnetic core 220 of this embodiment. Compared with the solution in which the safe distance groove 112 is not provided, it is equivalent to increasing a distance of side walls of the two safe distance grooves 112 perpendicular to the first direction X, thereby increasing the creepage distance between the pin 180 and the first magnetic core 210 or the second magnetic core 220, to further ensure the security of the transformer in use.

In summary, in the transformer of this embodiment, through disposing the first magnetic core 210 in the mounting part 10 located inside the winding frame 100, and winding the winding 300 on the outer side of the first magnetic core 210, there is an overlap part between the magnetic core 200 with the winding 300 and each of the two side walls 110 in the third direction Z. That is, the installation of the magnetic core 200 and the winding 300 makes more use of a space inside the winding frame 100, which reduces a length of the transformer in the third direction Z compared with the solution in the related art, which is beneficial to reducing the overall size of the transformer, and meets the development need for miniaturization of the transformer.

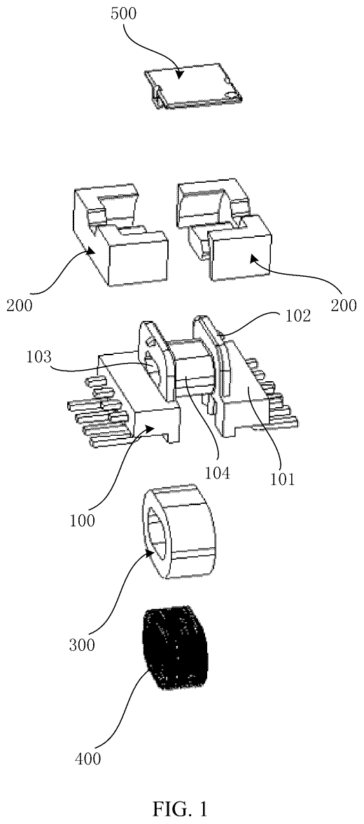

Therefore, taking the prior art shown in FIG. 1 and the embodiment of the present application shown in FIG. 3 as examples, compared with the prior art, the present application changes the winding part 102 of the winding frame 100 from a four-sided enclosed structure in the prior art into an open structure surrounded by three sides, so that an assembly manner of the magnetic core 200 changes from left-right assembly to up-down assembly. The winding 300 is changed from being wound on the magnetic core 200 indirectly through the wire groove 104 in the prior art to being directly wound on the magnetic core 200 in the present application. Thereby an assembly manner and sequence between the magnetic cores 200 and between the magnetic core 200 and the winding 300 are all changed. In addition, in the present application, both ends of the base 101 in the prior art are erected to form the two side walls 110, thereby solving a problem of insufficient security distance between the magnetic core 200 and the pin 180 after the structure is changed.

In the description of the present application, it should be understood that, an orientation or positional relationship indicated by terms such as “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, “circumferential” is based on the orientation or positional relationship shown in the attached drawings. It is only for the convenience of describing the present application and simplifying the description, and does not indicate or imply that the devices or elements referred to must have a specific orientation, be constructed and operate in a specific orientation, and therefore cannot be construed as limiting the present application.

In the present application, unless otherwise clearly defined and limited, the terms “install”, “link”, “connect”, “fix” and other terms should be understood in a broad sense, for example, may be a fixed connection, may also be a detachable connection, or integrated; may be directly connected, may also be indirectly connected through an intermediate medium; may be an internal connection of two components or an interaction between two components. For those of ordinary skill in the art, the specific meanings of the above terms in the present application may be understood according to specific situations.

It should be noted that, in the description of the present application, the terms “first” and “second” are only used to describe different components for convenience, and cannot be understood as indicating or implying a sequential relationship, relative importance, or implicitly indicating the number of indicated technical features. Thus, the features defined with “first” and “second” may explicitly or implicitly include at least one of the features.

The embodiments or implementations in the present application are described in a progressive manner, each embodiment focuses on differences from other embodiments, and the same similar parts between the various embodiments can be referred to each other.

In the description of the present application, the description of referring terms such as “one implementation”, “some implementations”, “illustrative implementation”, “example”, “specific example”, or “some examples” means that a particular feature, structure, material, or characteristic described in conjunction with an embodiment or example is included in at least one implementation or example of the present application. In the present application, schematic expressions of the above terms do not necessarily refer to the same implementation or example. Moreover, the described specific features, structures, materials, or characteristics may be combined in a suitable manner in any one or more implementations or examples.

Finally, it should be noted that the above embodiments are only used to illustrate the technical solutions of the present application, but not to limit them. Although the present application has been described in detail with reference to the foregoing embodiments, those skilled in the art should understand that the technical solutions recorded in the foregoing embodiments may still be modified, or some or all of the technical features thereof may be equivalently replaced. However, these modifications or replacements do not make the essence of the corresponding technical solutions deviate from the scope of the technical solutions of the embodiments of the present application.

What is claimed is:

1. A transformer comprising a winding frame, a first magnetic core, a second magnetic core and a winding, wherein the winding frame comprises two side walls oppositely disposed along a first direction and a bottom wall connecting the two side walls; along a second direction, both sides of the bottom wall are each provided with a stop plate; a length of the stop plate in a third direction is less than a length of each of the two side walls in the third direction; the bottom wall, the two side walls and the two stop plates together around form a mounting part; the first magnetic core is at least partially located in the mounting part; the winding is wound on an outer side of the first magnetic core, the bottom wall and the two stop plates; the second magnetic core, outside of the winding, is provided covering part of the winding, and is connected to the first magnetic core;
wherein the first direction, the second direction and the third direction are perpendicular to each other.

2. The transformer according to claim 1, wherein in the third direction, the bottom wall is connected to a middle part of the two side walls, and the bottom wall and the two side walls together form a winding space;
wherein a length of the winding in the third direction is less than the length of each of the two side walls in the third direction.

3. The transformer according to claim 2, wherein the second magnetic core is cuboid-shaped, the first magnetic core comprises a first top pillar and first side pillars vertically connected to two opposite ends of the first top pillar, and an end of each of the first side pillars away from the first top pillar is connected to the second magnetic core.

4. The transformer according to claim 3, wherein in the second direction, a length of the second magnetic core is less than or equal to a length of the first top pillar.

5. The transformer according to claim 4, wherein a projected area of the second magnetic core is equal to a projected area of the first top pillar in a plane perpendicular to the first direction;
especially, wherein in the first direction, a length of the second magnetic core is greater than or equal to a length of the first magnetic core.

6. The transformer according to claim 3, wherein a first transition surface is provided between the first top pillar and each of the first side pillars, and the first transition surface is an inclined surface or an arc surface.

7. The transformer according to claim 2, wherein the first magnetic core is cuboid-shaped, the second magnetic core comprises a second top pillar and second side pillars vertically connected to two opposite ends of the second top pillar, and an end of each of the second side pillars away from the second top pillar is connected to the first magnetic core.

8. The transformer according to claim 7, wherein in the second direction, a length of the first magnetic core is less than or equal to a length of the second top pillar.

9. The transformer according to claim 8, wherein a projected area of the first magnetic core is equal to a projected area of the second top pillar in a plane perpendicular to the first direction;
especially, wherein in the first direction, a length of the first magnetic core is greater than or equal to a length of the second magnetic core.

10. The transformer according to claim 7, wherein a second transition surface is provided between the second top pillar and each of the second side pillars, and the second transition surface is an inclined surface or an arc surface.

11. The transformer according to claim 2, wherein the first magnetic core comprises a first top pillar and first side pillars vertically connected to two opposite ends of the first top pillar, the second magnetic core comprises a second top pillar and second side pillars vertically connected to two opposite ends of the second top pillar, and an end of each of the first side pillars away from the first top pillar is connected to an end of a corresponding second side pillar away from the second top pillar.

12. The transformer according to claim 11, wherein a first transition surface is provided between the first top pillar and each of the first side pillars, and the first transition surface is an inclined surface or an arc surface;
a second transition surface is provided between the second top pillar and each of the second side pillars, and the second transition surface is an inclined surface or an arc surface.

13. The transformer according to claim 1, wherein in the second direction, a length of the bottom wall is less than a length of each of the two side walls, two ends of each of the two side walls are each further provided with a stop wall, and the stop wall is disposed toward the winding; and in the first direction, a notch for the winding to pass through is formed between the two adjacent stop walls.

14. The transformer according to claim 13, wherein an end of the stop plate away from the bottom wall is provided with an abutting plate connected to the stop wall.

15. The transformer according to claim 14, wherein in the first direction, a limiting plate is further connected to an end of the abutting plate away from a corresponding one of the two side walls, and the winding is located between the two limiting plates opposite to each other in the first direction;
especially, wherein a surface of the limiting plate away from the bottom wall is an inclined surface or an arc surface.

16. The transformer according to claim 1, wherein in the first direction, a partition plate is provided in a middle part of the stop plate, the winding comprises a first winding and a second winding, and the first winding and the second winding are respectively located on two sides of the partition plate.

17. The transformer according to claim 3, wherein at least one pin is further provided on a side of each of the two side walls away from the winding, and in the third direction, the pin is located at an end of a corresponding one of the two side walls away from the second magnetic core.

18. The transformer according to claim 17, wherein a safe distance groove is disposed on each of the two side walls, and the safe distance groove is used to increase a creepage distance between the pin and the first magnetic core and/or the second magnetic core.

19. The transformer according to claim 18, wherein each of the two side walls comprises a first surface and a third surface oppositely disposed along the second direction and a second surface and a fourth surface oppositely disposed along the third direction; the safe distance groove comprises a first groove segment disposed on the first surface, a second groove segment disposed on the second surface, a third groove segment disposed on the third surface, and a fourth groove segment disposed on the fourth surface; the first groove segment, the second groove segment, the third groove segment, and the fourth groove segment are interconnected with each other.

20. The transformer according to claim 8, wherein in a plane perpendicular to the third direction, a projected area of the second magnetic core is greater than or equal to a projected area of the first magnetic core.
